(19) United States
(12) Patent Application Publication
(10) Pub. No.: US 2025/0358738 A1
(43) Pub. Date: Nov. 20, 2025

(54) TECHNIQUES FOR CELL GROUP-SPECIFIC UPLINK WAKE-UP SIGNAL CONFIGURATION FOR ON-DEMAND SYSTEM INFORMATION BLOCKS

(71) Applicant: QUALCOMM Incorporated, San Diego, CA (US)

(72) Inventors: Jianghong LUO, Skillman, NJ (US); Hung Dinh LY, San Diego, CA (US); Navid ABEDINI, Basking Ridge, NJ (US); Qing LI, PRINCETON JUNCTION, NJ (US)

(21) Appl. No.: 18/666,614

(22) Filed: May 16, 2024

(51) Int. Cl. H04W 52/02; H04L 5/00; H04W 8/22

(52) U.S. Cl. CPC H04W 52/0219; H04L 5/0053; H04W 8/22; H04W 52/0235

(57) ABSTRACT

Methods, systems, and devices for wireless communications are described. Techniques described herein may enable a user equipment (UE) to identify one or more groups of network energy saving (NES) cells that may share an uplink wake-up signal (WUS) configuration for requesting a system information block (SIB). For example, the UE may receive a configuration indicating the groups of NES cells, a first set of uplink WUS parameters that are shared between NES cell groups, and second sets of uplink WUS parameters that are NES cell group-specific. The UE may transmit the uplink WUS to an NES cell or to a non-NES anchor cell to request an SIB for one or more NES cells or for one or more NES cell groups. Upon reception of the uplink WUS, the NES cell or non-NES cell may transmit one or more SIBs to the UE.

### FIELD OF TECHNOLOGY

The following relates to wireless communications, including techniques for cell group-specific uplink wake-up signal (WUS) configuration for on-demand system information blocks (SIBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving signaling indicating one or more cell groups, a first configuration including a first set of parameters, and a second configuration including one or more sub-configurations of one or more second sets of parameters, where each cell group includes at least one network energy saving (NES) cell, where the first set of parameters is common across the one or more cell groups, and where each respective second set of parameters is associated with a respective cell group of the one or more cell groups and transmitting an uplink wake-up signal (WUS) based on the received signaling.

A UE for wireless communications is described. The UE may include one or more memories storing processor executable code, and one or more processors coupled with the one or more memories. The one or more processors may individually or collectively be operable to execute the code to cause the UE to receive signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups and transmit an uplink WUS based on the received signaling.

Another UE for wireless communications is described. The UE may include means for receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups and means for transmitting an uplink WUS based on the received signaling.

A non-transitory computer-readable medium storing code for wireless communications is described. The code may include instructions executable by one or more processors to receive signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups and transmit an uplink WUS based on the received signaling.

In some examples of the method, UEs, and non-transitory computer-readable medium described herein, transmitting the uplink WUS may include operations, features, means, or instructions for selecting at least a first NES cell of a first cell group of the one or more cell groups and transmitting the uplink WUS in accordance with the first configuration and a first sub-configuration of one or more sub-configurations that may be associated with the first cell group.

Some examples of the method, UEs, and non-transitory computer-readable medium described herein may further include operations, features, means, or instructions for receiving, in response to the uplink WUS, at least one system information block (SIB) including system information for at least the first NES cell of the first cell group.

Some examples of the method, UEs, and non-transitory computer-readable medium described herein may further include operations, features, means, or instructions for transmitting a capability message indicating a quantity of SIBs, where the receiving the at least one SIB may be in accordance with the capability message.

In some examples of the method, UEs, and non-transitory computer-readable medium described herein, the first set of parameters, the one or more second sets of parameters, or both include one or more parameters related to a waveform generation for the uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more synchronization signal blocks (SSBs), or any combination thereof.

In some examples of the method, UEs, and non-transitory computer-readable medium described herein, transmitting the uplink WUS in accordance with a first uplink WUS configuration may include operations, features, means, or instructions for transmitting the uplink WUS in accordance with a random access channel (RACH) procedure.

Some examples of the method, UEs, and non-transitory computer-readable medium described herein may further include operations, features, means, or instructions for transmitting a message indicating a first NES cell, a cell group of the one or more cell groups that includes the first NES cell, or both.

In some examples of the method, UEs, and non-transitory computer-readable medium described herein, receiving the signaling indicating the one or more cell groups may include operations, features, means, or instructions for receiving the signaling via a broadcast message or a unicast message.

Some examples of the method, UEs, and non-transitory computer-readable medium described herein may further include operations, features, means, or instructions for receiving second signaling indicating an update to a first sub-configuration of the one or more sub-configurations and transmitting a retransmission of the uplink WUS in accordance with the updated first sub-configuration.

In some examples of the method, UEs, and non-transitory computer-readable medium described herein, the received signaling includes an indication of one or more NES cells included in a cell group of the one or more cell groups, physical layer cell identities of one or more NES cells included in a cell group of the one or more cell groups, a quantity of cell groups of the one or more cell groups, a quantity of NES cells in a cell group of the one or more cell groups, or any combination thereof.

A method for wireless communications by a network entity is described. The method may include establishing a connection with a UE and outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

A network entity for wireless communications is described. The network entity may include one or more memories storing processor executable code, and one or more processors coupled with the one or more memories. The one or more processors may individually or collectively be operable to execute the code to cause the network entity to establish a connection with a UE and output, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

Another network entity for wireless communications is described. The network entity may include means for establishing a connection with a UE and means for outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

A non-transitory computer-readable medium storing code for wireless communications is described. The code may include instructions executable by one or more processors to establish a connection with a UE and output, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

In some examples of the method, network entities, and non-transitory computer-readable medium described herein, the first set of parameters, the one or more second sets of parameters, or both include one or more parameters related to a waveform generation for an uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more SSBs, or any combination thereof.

Some examples of the method, network entities, and non-transitory computer-readable medium described herein may further include operations, features, means, or instructions for obtaining a message indicating a first NES cell, a cell group of the one or more cell groups that includes the first NES cell, or both.

Some examples of the method, network entities, and non-transitory computer-readable medium described herein may further include operations, features, means, or instructions for outputting second signaling indicating an update to a first sub-configuration of the one or more sub-configurations.

In some examples of the method, network entities, and non-transitory computer-readable medium described herein, the signaling includes an indication of one or more NES cells included in a cell group of the one or more cell groups, physical layer cell identities of one or more NES cells included in a cell group of the one or more cell groups, a quantity of cell groups of the one or more cell groups, a quantity of NES cells in a cell group of the one or more cell groups, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for cell group-specific uplink wake-up signal (WUS) configuration for on-demand system information blocks (SIBs) in accordance with one or more aspects of the present disclosure.

FIG. 2 shows an example of a wireless communications system that supports techniques for cell group-specific uplink WUS configuration for on-demand SIBs in accordance with one or more aspects of the present disclosure.

FIG. 3 shows an example of a cell diagram that supports techniques for cell group-specific uplink WUS configuration for on-demand SIBs in accordance with one or more aspects of the present disclosure.

FIG. 4 shows an example of a process flow that supports techniques for cell group-specific uplink WUS configuration for on-demand SIBs in accordance with one or more aspects of the present disclosure.

FIGS. 5 and 6 show block diagrams of devices that support techniques for cell group-specific uplink WUS configuration for on-demand SIBs in accordance with one or more aspects of the present disclosure.

FIG. 7 shows a block diagram of a communications manager that supports techniques for cell group-specific uplink WUS configuration for on-demand SIBs in accordance with one or more aspects of the present disclosure.

FIG. 8 shows a diagram of a system including a device that supports techniques for cell group-specific uplink WUS configuration for on-demand SIBs in accordance with one or more aspects of the present disclosure.

FIGS. 9 and 10 show block diagrams of devices that support techniques for cell group-specific uplink WUS configuration for on-demand SIBs in accordance with one or more aspects of the present disclosure.

FIG. 11 shows a block diagram of a communications manager that supports techniques for cell group-specific uplink WUS configuration for on-demand SIBs in accordance with one or more aspects of the present disclosure.

FIG. 12 shows a diagram of a system including a device that supports techniques for cell group-specific uplink WUS configuration for on-demand SIBs in accordance with one or more aspects of the present disclosure.

FIGS. 13 through 17 show flowcharts illustrating methods that support techniques for cell group-specific uplink WUS configuration for on-demand SIBs in accordance with one or more aspects of the present disclosure.

### DETAILED DESCRIPTION

In some wireless communication systems, a user equipment (UE) may communicate with a network entity using one or more parameters configured via a system information block (SIB) (e.g., an SIB1, an SIBx). Some network entities may be network energy saving (NES) cells, that may operate in a sleep mode and may transmit SIBs on-demand (e.g., in response to receiving an uplink wake-up signal (WUS) from the UE, rather than periodically). In some examples, the UE may transmit the uplink WUS according to an uplink WUS configuration. However, if multiple NES cells share a same uplink WUS configuration (e.g., and overlapping coverage areas), the NES cells may each receive the uplink WUS from the UE, which may result in relatively less network energy savings as a result of receiving an uplink WUS intended for a different NES cell. Accordingly, the UE may use one or more different uplink WUS configurations for one or more different NES cells. In some examples, however, using a different uplink WUS configuration for each NES cell may result in relatively larger signaling overhead and less efficient resource allocation than one or more NES cells that share an uplink WUS configuration.

Accordingly, techniques described herein may enable the UE to identify one or more groups of NES cells that may share an uplink WUS configuration. For example, the UE may receive a configuration (e.g., from an NES cell, from a non-NES cell) indicating the groups of NES cells, a first set of uplink WUS parameters that are shared between NES cell groups, and second sets of uplink WUS parameters that are NES cell group-specific. The UE may transmit a message (e.g., a random access channel (RACH) message) to the NES cell or to another cell indicating an NES cell or an NES cell group for which the UE may transmit the uplink WUS. In some examples, an NES cell group may include NES cells with non-overlapping coverage areas, which may decrease a likelihood of an NES cell receiving an uplink WUS intended for another NES cell. In some examples, an NES cell group may include NES cells with overlapping coverage areas, which may increase an uplink WUS resource allocation efficiency. The UE may transmit the uplink WUS to an NES cell or to the non-NES cell to request an SIB for one or more NES cells or for one or more NES cell groups. Upon reception of the uplink WUS, the NES cell or non-NES cell may transmit one or more SIBs to the UE.

Aspects of the disclosure are initially described in the context of wireless communications systems. Aspects of the disclosure are further illustrated by and described with reference to cell diagrams, process flows, apparatus diagrams, system diagrams, and flowcharts that relate to techniques for cell group-specific uplink WUS configuration for on-demand SIBs.

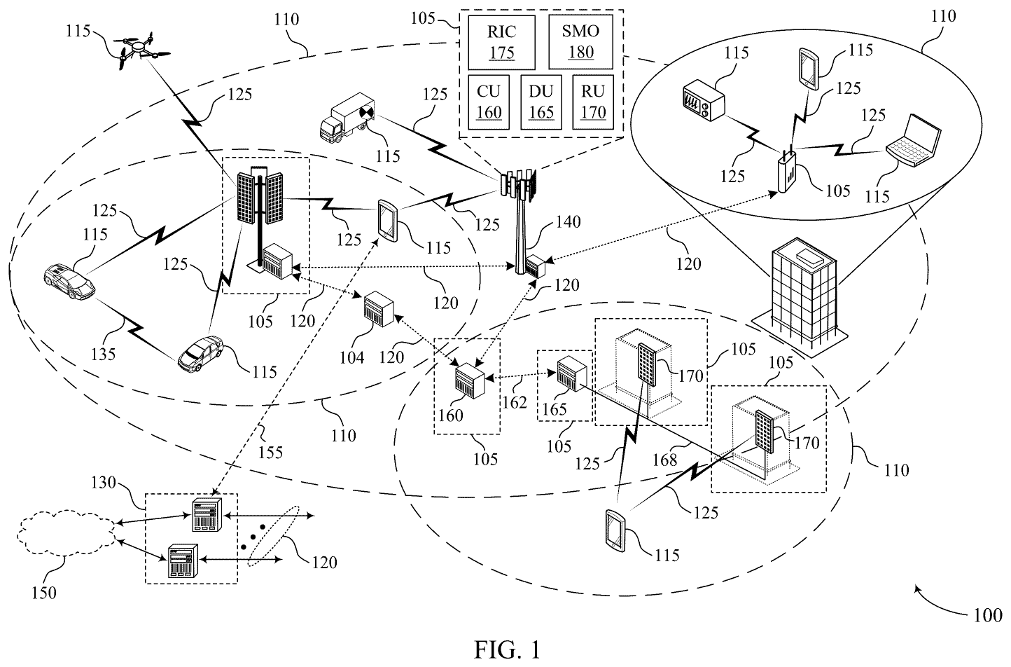

FIG. 1 shows an example of a wireless communications system 100 that supports techniques for cell group-specific uplink WUS configuration for on-demand SIBs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical layer cell identity (PCI), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 or network entities 105 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 and network entities 105 may include entering a power saving deep sleep mode when not engaging in active communications, operating using a limited bandwidth (e.g., according to narrowband communications), or a combination of these techniques. For example, some UEs 115 or network entities 105 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communication system 100, a network entity 105 may be a NES cell. In such examples, to decrease power consumption of the NES cell, the NES cell may transmit SIBs indicating system information to a UE 115 in response to an uplink WUS from the UE 115 (e.g., rather than periodically). Such techniques may be referred to herein as on-demand SIBs. In some examples, the UE 115 may receive a configuration for the uplink WUS from the NES cell, transmit the uplink WUS (e.g., an SIB request) to the NES cell, and receive the SIB (e.g., an SIB1) from the NES cell. In some examples, the UE 115 may receive the configuration for the uplink WUS from a non-NES network entity 105 (e.g., an anchor cell, a non-NES cell, a Cell A that periodically transmits at least its own SIB1), transmit the uplink WUS (e.g., an SIB request) to the NES cell, and receive the SIB (e.g., an SIB1) from the NES cell. In some examples, the UE 115 may receive the configuration for the uplink WUS from the non-NES network entity 105, transmit the uplink WUS (e.g., an SIB request) to the non-NES network entity 105, and receive one or more SIBs associated with one or more NES cells from the non-NES network entity 105 (e.g., receiving an SIBx message from the non-NES network entity 105, which may include the SIBs of one or more NES cells 105 in the coverage area of the non-NES network entity 105). In such examples, the UE 115 may receive synchronization signal blocks (SSBs), other system information, and/or one or more paging messages from either or both of the NES cell or the non-NES network entity 105. The UE 115 may perform a RACH procedure with the NES cell based on receiving the SIB.

In some aspects, the UE 115 may identify one or more groups of NES cells that may share an uplink WUS configuration. For example, the UE 115 may receive a configuration (e.g., from an NES cell, from a non-NES network entity 105) indicating the groups of NES cells, a first set of uplink WUS parameters that are shared between NES cell groups, and second sets of uplink WUS parameters that are NES cell group-specific. In some examples, the UE 115 may transmit a message of a RACH procedure (e.g., a msg3 of a four-step RACH procedure) to the NES cell or to the non-NES network entity 105 indicating an NES cell or an NES cell group for which the UE may transmit the uplink WUS.

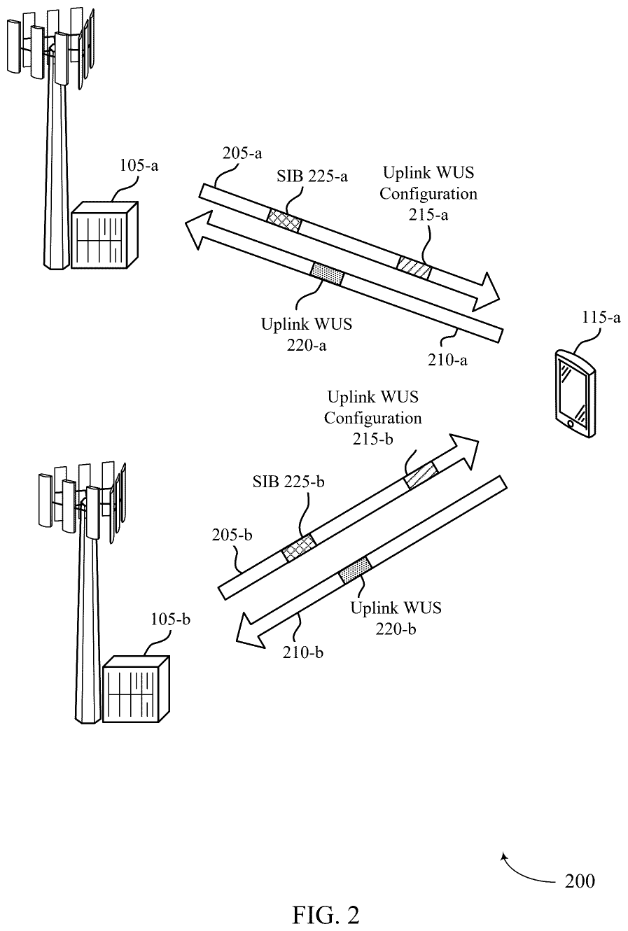

FIG. 2 shows an example of a wireless communications system 200 that supports techniques for cell group-specific uplink WUS configuration for on-demand SIBs in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or one or more network entities 105 (e.g., an NES cell 105-a, a non-NES cell 105-b), which may be examples of the corresponding devices as described with reference to FIG. 1. As described herein, an NES cell 105 may be a network entity 105 that transmits an SIB in response to a request from a UE 115 (e.g., an uplink WUS) rather than periodically. A non-NES cell 105 (e.g., an anchor cell, a non-NES network entity, Cell A) may be a network entity 105 that transmits an SIB associated with the non-NES cell 105 periodically. In some examples, the non-NES cell 105-b may be associated with one or more NES cells 105. For example, the non-NES cell 105-b may include one or more NES cells 105 within the coverage area of the non-NES cell 105-b. In some examples, a NES cell may be overlapped or partially overlapped with one or more non-NES cell(s) (e.g., one or more Cell A(s)).

In some examples of the wireless communication system 200, a UE 115-a may request an on-demand SIB from one or more NES cells 105 (e.g., an NES cell 105-a) by transmitting an uplink WUS 220. In some examples, the UE 115-a may receive an uplink WUS configuration 215-a from the NES cell 105-a (e.g., via a downlink channel 205-a) indicating one or more parameters related to transmission of the uplink WUS 220. Additionally, or alternatively, the UE 115-a may receive an uplink WUS configuration 215-b from a non-NES cell 105-b (e.g., via a downlink channel 205-b) indicating one or more parameters related to transmission of the uplink WUS 220. The UE 115-a may transmit an uplink WUS 220-a to the NES cell 105-a (e.g., via an uplink channel 210-a) and/or an uplink WUS 220-b to the non-NES cell 105-b (e.g., via an uplink channel 210-b) to request an SIB for the NES cell 105-a (e.g., and/or one or more other NES cells 105). The NES cell 105-a and/or the non-NES cell 105-b may accordingly transmit an SIB 225-a (e.g., an SIB1) or an SIB 225-b (e.g., an SIBx), respectively, to the UE 115-a in response to the corresponding uplink WUS 220.

In some examples, the uplink WUS 220-a and/or the uplink WUS 220-b may be messages of a RACH procedure (e.g., a physical RACH (PRACH) procedure). For example, the uplink WUS 220-a and/or the uplink WUS 220-b may be a first message (e.g., msg1, a preamble) of a RACH procedure. Such a RACH procedure may be a contention-free RACH procedure (e.g., a two-step RACH procedure including a RACH preamble and a random access response (RAR) message) or a contention-based RACH procedure (e.g., a four-step RACH procedure including a RACH preamble, an RAR, a msg3, and a msg4).

In a first deployment scenario, as illustrated with reference to FIG. 2, the non-NES cell 105-b may be a relatively larger cell including one or more relatively smaller NES cells 105 (e.g., the NES cell 105-a). Such examples may be referred to as an overlay deployment scenario. In such examples, the UE 115-a may receive the uplink WUS configuration 215-b from the non-NES cell 105-b, and the NES cell 105-a may perform uplink WUS 220-a monitoring and SIB 225-a transmission (e.g., on-demand SIB1). In such examples, if a first uplink WUS 220 for a first NES cell 105 and a second uplink WUS 220 for a second NES cell 105 have a same configuration, the first NES cell 105 may receive an uplink WUS 220 transmitted by the UE 115 (e.g., an uplink WUS intended to request an SIB of the second NES cell 105). The first NES cell 105 may transmit an SIB in response to the uplink WUS, which may increase power consumption at the second NES cell 105 by causing the first NES cell to transmit an SIB that is not requested by the UE 115. If the first uplink WUS 220 for the first NES cell 105 and the second uplink WUS 220 for the second NES cell 105 have different configurations, relatively more communication resources of the wireless communication system 200 may be allocated for uplink WUSs 220, which may decrease an efficiency of resources allocation in the wireless communication system 200.

In a second deployment scenario, the non-NES cell 105-b may transmit the uplink WUS configuration 215-b, monitor for the uplink WUS 220-b, and transmit the SIB 225-b (e.g., an on-demand SIBx including one or more on-demand SIB1s for a corresponding one or more NES cells 105 associated with the NES cell 105-b). The SIBx may be one of one or more system information messages associated with the non-NES cell 105-b. Accordingly, the UE 115-a may use a RACH-based on-demand system information request framework (e.g., a msg-1 based contention-free RACH procedure or a msg-3 based contention-based RACH procedure). However, in such examples, the non-NES cell 105 may be associated with multiple NES cells 105, and a payload of the SIB 225-b may accordingly be relatively larger than a payload of an SIB 225 associated with one NES cell 105. For example, the payload of the SIB 225-b may be larger than a payload size that is supported by the SIB 225-b and/or larger than a payload size storable by the UE 115-a (e.g., for some types of UE 115-a, such as a redcap UE 115-a).

In a third deployment scenario, the NES cell 105-a may transmit the uplink WUS configuration 215-a, monitor for the uplink WUS 220-a, and transmit the SIB 225-a (e.g., an on-demand SIB 1 associated with the NES cell 105-a). Such deployment scenarios may be referred to as standalone deployment scenarios. In such examples, the NES cell 105-a may transmit the uplink WUS configuration 215-a as part of a broadcast message (e.g., a physical broadcast channel (PBCH) message), which may have a relatively smaller payload size than some other messages. The PBCH message may therefore have relatively few bits usable by the NES cell 105-a for the uplink WUS configuration 215-a (e.g., reserved bits for a master information block (MIB)). Accordingly, one or more parameters associated with the uplink WUS configuration 215-a may be predefined (e.g., as a rule in a technical specification). However, as described herein with reference to the first deployment scenario, if multiple NES cells 105 share a same configuration for uplink WUSs 220, the NES cells 105 may experience relatively increased power consumption than cases in which the NES cells 105 monitor for uplink WUSs 220 with different configurations.

Accordingly, for the first, second, and third deployment scenarios, one or more NES cells 105 may be part of an NES cell group of one or more NES cell groups with cell group-specific uplink WUS configurations 215. For example, a first set of parameters of an uplink WUS configuration 215 may be shared between one or more NES cell groups, and a second set of parameters (e.g., a sub-configuration) of the uplink WUS configuration 215 may be specific to one NES cell group. Such techniques may result in relatively decreased power consumption, relatively decreased signaling overhead, and/or relatively more efficient utilization of communication resources.

For example, for the second deployment scenario, the UE 115-a may indicate, in a capability report to the non-NES cell 105-b, a quantity of SIB1s (e.g., a maximum quantity of SIB1s) that the UE 115-a may receive as part of the SIB 225-b (e.g., the SIBx). In some examples, the indication may be explicit (e.g., an explicit quantity of SIBs) or implicit (e.g., as a payload size or quantity of bits receivable by the UE 115-a as part of the SIB 225-b). The UE 115-a may transmit the uplink WUS 220-b according to an uplink WUS configuration 215-a associated with a first NES cell group. In some examples, the non-NES cell 105-b may have one SIB 225-b (e.g., one on-demand SIBx), and the non-NES cell 105-b may determine which SIBs (e.g., associated with NES cells 105 of the first NES cell group) to include in the SIBx. Additionally, or alternatively, each NES cell group may be associated with a different SIB 225 (e.g., a different SIBx including SIB1s of the corresponding NES cell group), and the non-NES cell 105-b may determine which SIBx to transmit to the UE 115-a. In some examples, the non-NES cell 105-b may transmit the SIBx in SSB beam directions associated with the received uplink WUS 220-b.

For the third deployment scenario, the UE 115-a may identify a mapping table between NES cells 105 to uplink WUS configuration 215. For example, the UE 115-a may be configured (e.g., pre-configured) with the mapping table that maps uplink WUS configurations 215 to respective PCIs of NES cells 105 and/or with respective NES cell groups. The NES cell 105-a may accordingly indicate a PCI and/or a NES cell group via the PBCH message, which may enable the UE 115-a to identify the uplink WUS configuration 215-a for the NES cell 105-a with relatively less signaling overhead.

In some examples, the first and/or respective second sets of parameters may include waveform generation parameters for the uplink WUS 220; time, frequency, and/or cyclic shift (e.g., code) domain resources for the uplink WUS 220; a transmission power for the uplink WUS 220; a configuration for a retransmission of the uplink WUS 220; a configuration for an acknowledgment for the uplink WUS 220 (e.g., a HARQ message transmitted by the NES cell 105 or non-NES cell 105 receiving the uplink WUS 220); and/or one or more SSB-related configurations. For example, the one or more SSB-related configurations may include a mapping between SSBs (e.g., SSB identifiers (IDs)) and uplink WUSs 220.

In some aspects, a NES cell group may include one NES cell 105, all NES cells 105 associated with a non-NES cell 105, a subset of NES cells 105 associated with a non-NES cell 105 (e.g., such that an NES cell 105 of any NES cell group is associated with the non-NES cell 105), or all NES cells 105 in a standalone deployment scenario. Each NES cell group may include a same or different quantity of NES cells 105. In some examples, NES cells 105 in an NES cell group may not have overlapping coverage areas. In some examples, one or more NES cells 105 in an NES cell group may have overlapping coverage areas. In some examples, one or more NES cell groups may be pre-defined (e.g., according to a rule in a specification).

In some examples, the UE 115-a may transmit the cell group-specific uplink WUS 220 as part of a contention-free (e.g., two-step, msg1-based) RACH procedure (e.g., a RACH preamble or msg1 of the RACH procedure). In such examples, the first set of parameters may include a frame structure parameter (e.g., a parameter tdd-UL-DL-ConfigurationCommon), one or more SSB-related parameters (e.g., parameters ssb-PositionsInBurst, ss-PBCH-BlockPower, rsrp-ThresholdSSB, SMTC, absolute FrequencySSB, or offsetToPointA), uplink or downlink bandwidth part parameters (e.g., a parameter locationAndBandwidth or a subcarrier spacing (SCS)), downlink frequency information (e.g., a parameter frequencyBand), uplink frequency information (e.g., parameters frequencyBand or absoltueFrequencyPointA for frequency division duplex (FDD) communications or supplemental uplink (SUL) frequency bands, a parameter p-Max, a parameter additionalSpectrumEmission), and/or RACH related parameters (e.g., parameters msg1-FDM, msg1-FrequencyStart, ssb-perRACH-Occasion, zeroCorrelationZoneConfig, restrictedSetConfig, msg1-SubcarrierSpacing, preambleReceivedTargetPower, preambleTransMax, powerRampingStep, or ra-ResponseWindow). A respective second set of parameters may include RACH related parameters (e.g., prach-ConfigurationIndex, ra-ssb-OccasionMaskIndex, prach-RootSequenceIndex, or ra-PreambleIndex).

In some examples, the UE 115-a may transmit the cell group-specific uplink WUS 220 as part of a contention-based (e.g., four-step, msg3-based) RACH procedure (e.g., a RACH preamble or msg1 of the RACH procedure). In such examples, the UE 115-a may explicitly indicate (e.g., to the non-NES cell 105-b) one or more target NES cells 105 for the UE 115-a to receive SIB1s by indicating the target NES cells 105 and/or NES cell groups associated with the target NES cells 105 via a third message of the RACH procedure (e.g., msg3). Additionally, or alternatively, the UE 115-a may implicitly indicate (e.g., to the target NES cells 105) one or more target NES cells 105 for the UE 115-a to receive SIB1s by transmitting the third message of the RACH procedure to the target NES cells 105 (e.g., via uplink grants provided in RAR messages from the target NES cells 105). In such examples, the first set of parameters and/or the respective second sets of parameters may include one or more contention-based RACH parameters (e.g., parameters totalNumberOfRA-Preambles, ssb-perRACH-OccasionAndCB-PreamblesPerSSB, ra-ContentionResolutionTimer, or msg3-transformPrecoder).

In some examples, an uplink WUS configuration 215 (e.g., from the NES cell 105-a or the non-NES cell 105-b) for a first NES cell group may indicate a set of NES cells 105 in the first NES cell group (e.g., PCIs associated with the set of NES cells 105), all NES cells 105 in any NES cell group (e.g., PCIs associated with all NES cells 105), a quantity of NES cell groups, a quantity of NES cells 105 in each NES cell group, a mapping between the NES cell groups and a list of system information (e.g., SIBxs) of the non-NES cell 105-b, the first set of parameters that is common across all NES cell groups, and/or one or more sub-configurations of second sets of parameters specific to the first NES cell group and one or more other NES cell groups (e.g., a first sub-configuration for the first NES cell group, a second sub-configuration for a second NES cell group, and so on).

In some examples, the UE 115-a may receive the uplink WUS configuration 215 via a broadcast message (e.g., as an SIB1 or another SIB such as SIBx of the non-NES cell 105-b, as an MIB of the NES cell 105-a). Additionally, or alternatively, the UE 115-a may receive the uplink WUS configuration 215 via a unicast message (e.g., a UE-specific RRC message, such as an RRC release message while the UE 115-a is in a connected state. In some examples, the UE 115-a may receive the uplink WUS configuration 215 via another message (e.g., a MAC control element (MAC-CE), a downlink control information (DCI)).

In some examples, the UE 115-a may receive an update to the uplink WUS configuration 215 (e.g., an update to one or more of the sub-configurations of second sets of parameters). For example, the UE 115-a may receive a message that dynamically updates the uplink WUS configuration 215. The UE 115-a may accordingly transmit a retransmission of the uplink WUS 220 in accordance with the updated uplink WUS configuration 215. The message may be a response to the uplink WUS 220 (e.g., an ACK or RAR message for a msg1-based PRACH procedure) or a unicast, broadcast, RRC, MAC-CE, or DCI message.

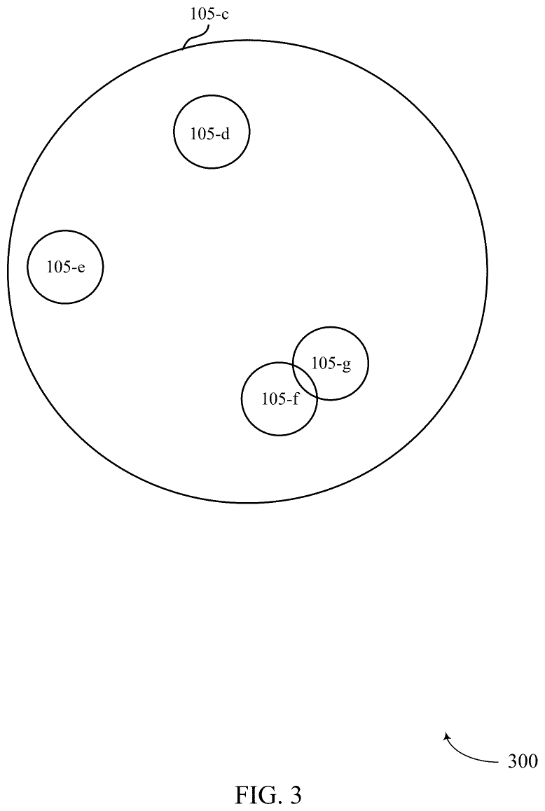

FIG. 3 shows an example of a cell diagram 300 that supports techniques for cell group-specific uplink WUS configuration for on-demand SIBs in accordance with one or more aspects of the present disclosure. The cell diagram 300 may implement or may be implemented by aspects of the wireless communications system 100 or the wireless communication system 200. For example, the cell diagram 300 may be implemented by a UE 115 or one or more network entities 105 (e.g., a non-NES cell 105-c, a NES cell 105-d, a NES cell 105-e, a NES cell 105-f, a NES cell 105-g), which may be examples of the corresponding devices as described with reference to FIG. 1.

In some examples, as described with reference to FIG. 2, a non-NES cell 105-c (e.g., an anchor cell, a cell A) may be in an overlay deployment scenario. For example, the non-NES cell 105-c may have a coverage area that includes multiple smaller cells that support NES, such as a set of NES cells 105 (e.g., a NES cell 105-d, a NES cell 105-e, a NES cell 105-f, a NES cell 105-g). A UE 115 may transmit an uplink WUS to the non-NES cell 105-c and/or one or more of the NES cells 105 according to an uplink WUS configuration.

In some examples, if the UE 115 uses a same uplink WUS configuration for the NES cell 105-g as for the NES cell 105-f, multiple NES cells 105 may receive an uplink WUS transmitted from the UE 115. For example, the NES cell 105-f may receive an uplink WUS transmitted from the UE 115 to the NES cell 105-g, and the NES cell 105-f may therefore be triggered to transmit an on-demand SIB (e.g., an SIB1) to the UE 115. The UE 115 may not intend to trigger the NES cell 105-f to transmit the SIB, which may increase power consumption at the NES cell 105-f.

Accordingly, multiple NES cells 105 (e.g., the NES cell 105-f and the NES cell 105-g with overlapping coverage areas) may have different uplink WUS configurations (e.g., sub-configurations). For example, to prevent the NES cell 105-f from monitoring for an uplink WUS intended for the NES cell 105-g (e.g., and vice-versa), the UE 115 may use a different configuration for the uplink WUS for the NES cell 105-g than for an uplink WUS for the NES cell 105-f. Thus, if the UE 115 transmits an uplink WUS using a configuration associated with the NES cell 105-g, NES cells 105 that share configured uplink WUS monitoring resources with the NES cell 105-g may monitor for the uplink WUS and transmit an SIB, and one or more other cells that do not share the uplink WUS configuration with the NES cell 105-g may not monitor for the uplink WUS. The NES cell 105-f may therefore drop or ignore the uplink WUS and refrain from transmitting the SIB. Such techniques may decrease power consumption of the NES cell 105-f.

Additionally, or alternatively, one or more NES cells 105 in the non-NES cell 105-c may share an uplink WUS configuration for signaling and resource overhead saving. For example, one or more NES cells 105 that are isolated such that the respective coverage areas of the one or more NES cells 105 do not overlap (e.g., the NES cell 105-d, the NES cell 105-e, the NES cell 105-f) may share uplink WUS configurations without monitoring for an uplink WUS that is intended for a different NES cell 105. For example, if the UE 115 is in a coverage area of the NES cell 105-d, the NES cell 105-e may not receive an uplink WUS transmitted by the UE 115 to the NES cell 105-d (e.g., as the coverage areas of the NES cell 105-d and the NES cell 105-e do not overlap). In other words, a target cell (e.g., the NES cell 105-d) nearby to the UE 115 (e.g., such that the UE 115 is within the coverage area of the target cell) may monitor for the uplink WUS and transmit the on-demand SIB, while one or more other cells that may not be nearby to the UE 115 (e.g., the NES cell 105-e, the NES cell 105-f) may not receive the uplink WUS.

Accordingly, to support greater network energy savings and more efficient allocation of resources, the NES cells 105 may be in NES cell groups that share configured resources for an uplink WUS. As described herein with reference to FIG. 2, an uplink WUS configuration for a set of NES cell groups may have a first set of parameters that are shared between the set of NES cell groups and a respective second sets of parameters (e.g., sub-configurations) that are specific to each uplink WUS configuration.

In some examples, NES cells 105 that have overlapping coverage areas (e.g., the NES cell 105-f and the NES cell 105-g) may be in different NES cell groups and may therefore not share a same uplink WUS configuration. NES cells 105 that do not have overlapping coverage areas (e.g., the NES cell 105-d, the NES cell 105-e, and the NES cell 105-f) may be in a same NES cell group, and may therefore share a same uplink WUS configuration.

Additionally, or alternatively, to greater increase an efficiency of allocated resources, one or more NES cells 105 with overlapping coverage areas may share an uplink WUS configuration. For example, the NES cell 105-f and the NES cell 105-g may share monitoring resources configured for monitoring for an uplink WUS, which may increase an amount of uplink resources available for other transmissions.

In some aspects, the non-NES cell 105-c may indicate the uplink WUS configuration for a respective NES cell group to each NES cell 105. For example, the non-NES cell 105-c may transmit a configuration for monitoring for the uplink WUS from the UE 115 to each NES cell 105 via a backhaul link (e.g., F1 application protocol (AP) interface or an inter-gNB Xn interface). The NES cells 105 may accordingly monitor for the uplink WUS from the UE 115 in accordance with the configuration. If an NES cell 105 receives an uplink WUS from the UE 115 in accordance with the configuration, the NES cell 105 may transmit an SIB (e.g., SIB1) to the UE 115 (e.g., over one or more SSBs or SSB beam directions associated with the detected uplink WUS).

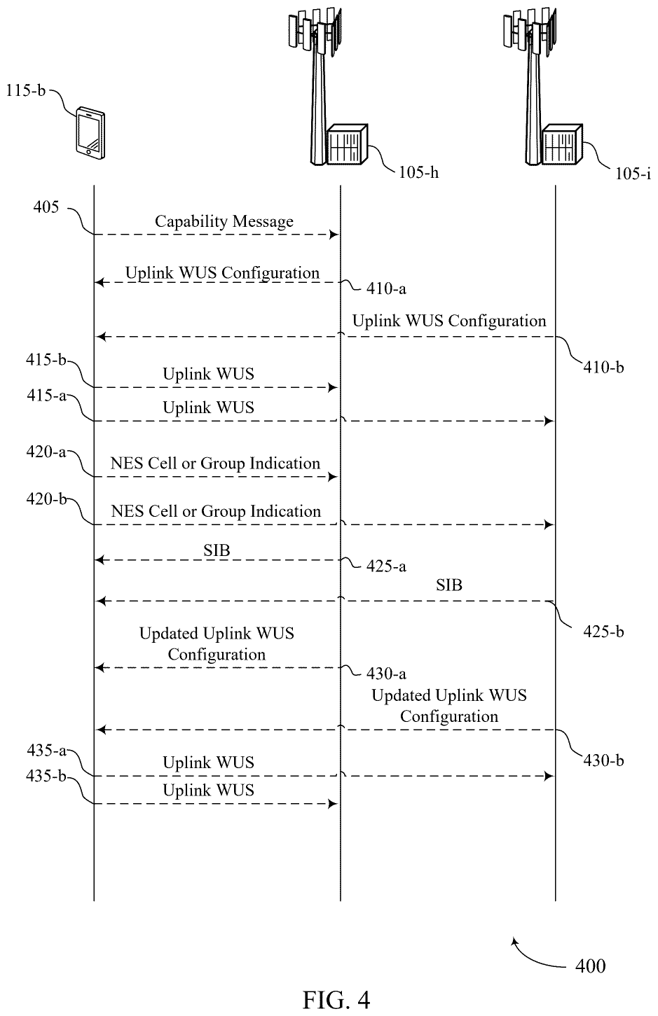

FIG. 4 shows an example of a process flow 400 that supports techniques for cell group-specific uplink WUS configuration for on-demand SIBs in accordance with one or more aspects of the present disclosure. The process flow 400 may implement or may be implemented by aspects of the wireless communications system 100, the wireless communication system 200 or the cell diagram 300. For example, the process flow 400 may be implemented by a UE 115 (e.g., a UE 115-b) or one or more network entities 105 (e.g., a non-NES cell 105-h, a NES cell 105-i), which may be examples of the corresponding devices as described with reference to FIG. 1.

In the following description of the process flow 400, the operations between the UE 115-b, the non-NES cell 105-h, and the NES cell 105-i may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the UE 115-b may transmit a capability message to the non-NES cell 105-h. The capability message may indicate, for example, a quantity (e.g., a maximum quantity) of SIB1s associated with NES cells 105 that the UE 115 may receive in an SIBx from the non-NES cell 105-h. Additionally, or alternatively, the capability message may indicate a quantity (e.g., a maximum quantity) of bits that the UE 115 may receive in an SIBx from the non-NES cell 105-h.

At 410-a or 410-b, the UE 115-b may receive signaling from the non-NES cell 105-h or the NES cell 105-i, respectively, indicating an uplink WUS configuration for transmitting an uplink WUS to request an SIB associated with one or more NES cells 105. For example, the signaling may indicate one or more NES cell groups (e.g., each including one or more NES cells), a first configuration of a first set of parameters for an uplink WUS that are shared between NES cell groups, and a set of sub-configurations of respective second sets of parameters that are specific to each NES cell group. In some examples, the NES cell 105-i may belong to a first NES cell group of the one or more NES cell groups. In some examples, the signaling may be a broadcast message, a unicast message, a MAC-CE, or a DCI.

In some examples, the received signaling may include an indication of one or more NES cells included 105 in a NES cell group of the one or more NES cell groups, PCIs of one or more NES cells 105 included in a NES cell group of the one or more NES cell groups, a quantity of NES cell groups of the one or more NES cell groups, and/or a quantity of NES cells 105 in an NES cell group of the one or more NES cell groups. In some examples, the first set of parameters, the second sets of parameters, or both may include parameters related to a waveform generation for the uplink WUS, time resources for the uplink WUS, frequency resources for the uplink WUS, a cyclic shift for the WUS, a transmission power of the WUS, configuration information for an acknowledgement to the uplink WUS (e.g., an ACK, an RAR), configuration information for retransmission of the uplink WUS, and/or configuration information for one or more SSBs.

At 415-a or 415-b, the UE 115-b may transmit an uplink WUS to the non-NES cell 105-h or to the NES cell 105-i, respectively, based on the received signaling. For example, the UE 115-b may select at least a first NES cell 105 (e.g., including the NES cell 105-i) or a NES cell group (e.g., the first NES cell group including the NES cell 105-i). The UE 115-b may transmit the uplink WUS according to the first set of parameters and a first sub-configuration (e.g., a second set of parameters) associated with the first NES cell group. In some examples, the UE 115-b may transmit the uplink WUS as part of a RACH procedure (e.g., as a RACH preamble, as a msg1).

In some examples, at 420-a or 420-b, the UE 115-b may transmit a message to the non-NES cell 105-h or the NES cell 105-i, respectively, indicating a first NES cell (e.g., the NES cell 105-i), an NES cell group (e.g., the first NES cell group), or both. For example, the UE 115-b may transmit the message to the non-NES cell 105-h to indicate one or more NES cells 105 for which the UE 115-b is requesting an SIB. Additionally, or alternatively, the UE 115-b may transmit the message to the one or more NES cells 105 for which the UE 115-b is requesting an SIB (e.g., the NES cell 105-i). The message may be a message of a RACH procedure (e.g., msg3).

At 425-a or 425-b, the UE 115-b may receive an SIB from the non-NES cell 105-h or the NES cell 105-i, respectively. For example, the UE 115-b may receive an SIBx from the non-NES cell 105-h including one or more SIB1 associated with one or more NES cells 105 (e.g., the one or more NES cells of the first NES cell group, the one or more NES cells indicated in the message). Additionally, or alternatively, the UE 115-b may receive an SIB1 from the NES cell 105-i.

In some examples, at 430-a or 430-b, the UE 115-b may receive second signaling (e.g., unicast, broadcast, MAC-CE, DCI, RAR) from the non-NES cell 105-h or the NES cell 105-i, respectively, indicating an update to one or more sub-configurations (e.g., an update to one or more second sets of parameters). For example, the second signaling may indicate an update to the first sub-configuration for the first NES cell group. The update may be for a retransmission of the uplink WUS.

In some examples, at 435-a or 435-b, the UE 115-b may transmit a retransmission of the uplink WUS to the non-NES cell 105-h or to the NES cell 105-i, respectively. For example, if the UE 115-b received the second signaling, the UE 115-b may retransmit the uplink WUS according to the updated sub-configuration. If the UE 115-b did not receive the second signaling, the UE 115-b may transmit the retransmission according to the first configuration and the first sub-configuration (e.g., according to one or more parameters related to retransmission of the uplink WUS indicated in the first configuration or the first sub-configuration).

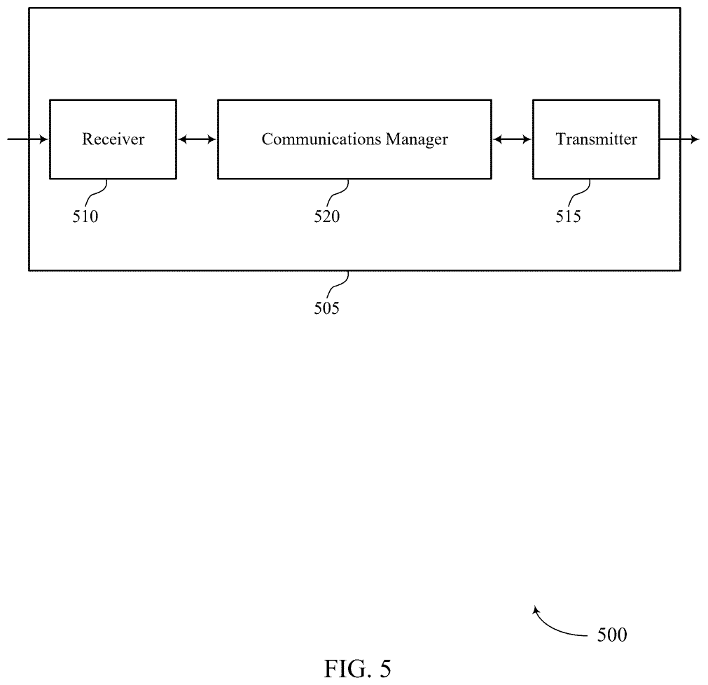

FIG. 5 shows a block diagram 500 of a device 505 that supports techniques for cell group-specific uplink WUS configuration for on-demand SIBs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for cell group-specific uplink WUS configuration for on-demand SIBs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for cell group-specific uplink WUS configuration for on-demand SIBs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for cell group-specific uplink WUS configuration for on-demand SIBs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The communications manager 520 is capable of, configured to, or operable to support a means for transmitting an uplink WUS based on the received signaling.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for NES cell group-specific uplink WUS configurations, which may result in reduced power consumption and more efficient utilization of communication resources.

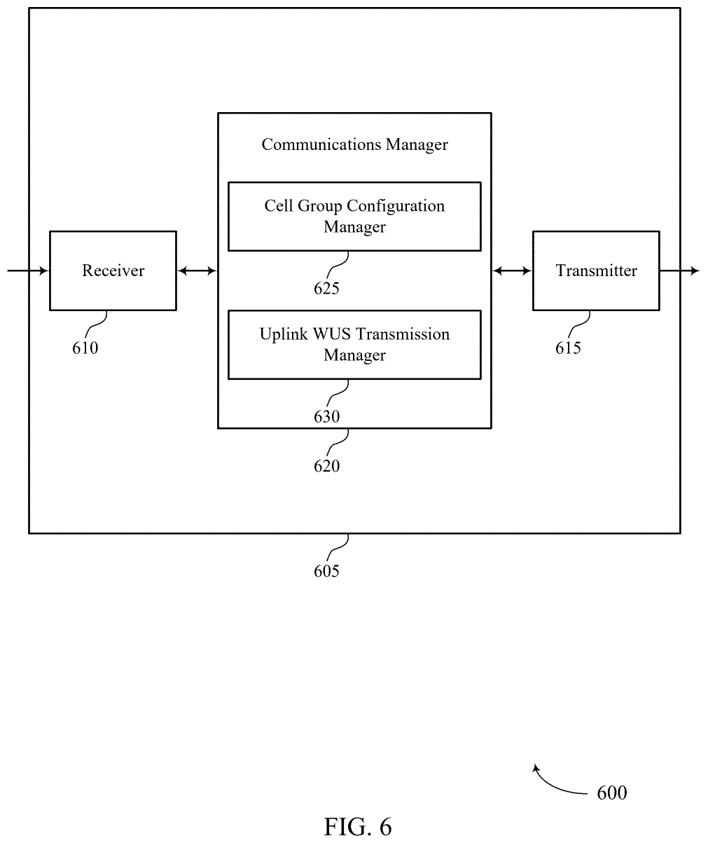

FIG. 6 shows a block diagram 600 of a device 605 that supports techniques for cell group-specific uplink WUS configuration for on-demand SIBs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for cell group-specific uplink WUS configuration for on-demand SIBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for cell group-specific uplink WUS configuration for on-demand SIBs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for cell group-specific uplink WUS configuration for on-demand SIBs as described herein. For example, the communications manager 620 may include a cell group configuration manager 625 an uplink WUS transmission manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The cell group configuration manager 625 is capable of, configured to, or operable to support a means for receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The uplink WUS transmission manager 630 is capable of, configured to, or operable to support a means for transmitting an uplink WUS based on the received signaling.

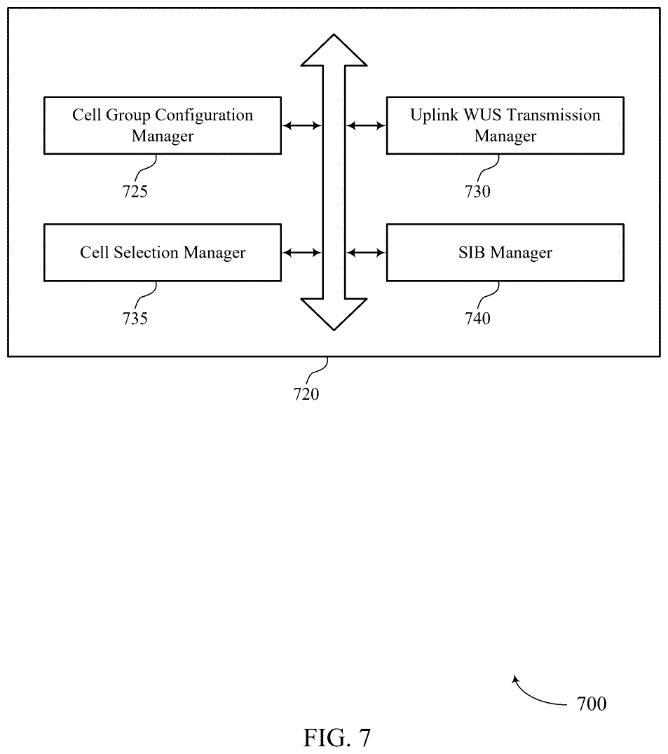

FIG. 7 shows a block diagram 700 of a communications manager 720 that supports techniques for cell group-specific uplink WUS configuration for on-demand SIBs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for cell group-specific uplink WUS configuration for on-demand SIBs as described herein. For example, the communications manager 720 may include a cell group configuration manager 725, an uplink WUS transmission manager 730, a cell selection manager 735, an SIB manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The cell group configuration manager 725 is capable of, configured to, or operable to support a means for receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The uplink WUS transmission manager 730 is capable of, configured to, or operable to support a means for transmitting an uplink WUS based on the received signaling.

In some examples, to support transmitting the uplink WUS, the cell selection manager 735 is capable of, configured to, or operable to support a means for selecting at least a first NES cell of a first cell group of the one or more cell groups. In some examples, to support transmitting the uplink WUS, the uplink WUS transmission manager 730 is capable of, configured to, or operable to support a means for transmitting the uplink WUS in accordance with the first configuration and a first sub-configuration of one or more sub-configurations that is associated with the first cell group.

In some examples, the SIB manager 740 is capable of, configured to, or operable to support a means for receiving, in response to the uplink WUS, at least one SIB including system information for at least the first NES cell of the first cell group.

In some examples, the SIB manager 740 is capable of, configured to, or operable to support a means for transmitting a capability message indicating a quantity of SIBs, where the receiving the at least one SIB is in accordance with the capability message.

In some examples, the first set of parameters, the one or more second sets of parameters, or both include one or more parameters related to a waveform generation for the uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more SSBs, or any combination thereof.

In some examples, to support transmitting the uplink WUS in accordance with a first uplink WUS configuration, the uplink WUS transmission manager 730 is capable of, configured to, or operable to support a means for transmitting the uplink WUS in accordance with a RACH procedure.

In some examples, the cell selection manager 735 is capable of, configured to, or operable to support a means for transmitting a message indicating a first NES cell, a cell group of the one or more cell groups that includes the first NES cell, or both.

In some examples, to support receiving the signaling indicating the one or more cell groups, the cell group configuration manager 725 is capable of, configured to, or operable to support a means for receiving the signaling via a broadcast message or a unicast message.

In some examples, the cell group configuration manager 725 is capable of, configured to, or operable to support a means for receiving second signaling indicating an update to a first sub-configuration of the one or more sub-configurations. In some examples, the uplink WUS transmission manager 730 is capable of, configured to, or operable to support a means for transmitting a retransmission of the uplink WUS in accordance with the updated first sub-configuration.

In some examples, the received signaling includes an indication of one or more NES cells included in a cell group of the one or more cell groups, PCIs of one or more NES cells included in a cell group of the one or more cell groups, a quantity of cell groups of the one or more cell groups, a quantity of NES cells in a cell group of the one or more cell groups, or any combination thereof.

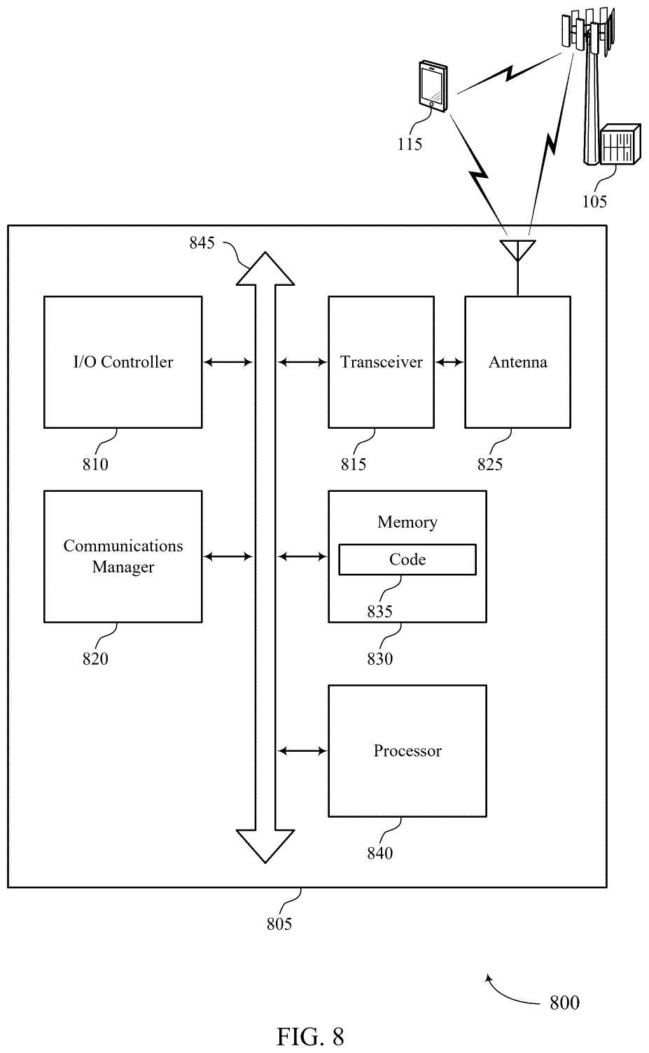

FIG. 8 shows a diagram of a system 800 including a device 805 that supports techniques for cell group-specific uplink WUS configuration for on-demand SIBs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for cell group-specific uplink WUS configuration for on-demand SIBs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The communications manager 820 is capable of, configured to, or operable to support a means for transmitting an uplink WUS based on the received signaling.

By including or configuring the communications manager 820 in accordance with examples as described herein, the device 805 may support techniques for NES cell group-specific uplink WUS configurations, which may result in reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for cell group-specific uplink WUS configuration for on-demand SIBs as described herein, or the at least one processor 840 and the at least one memory 830 may be otherwise configured to, individually or collectively, perform or support such operations.

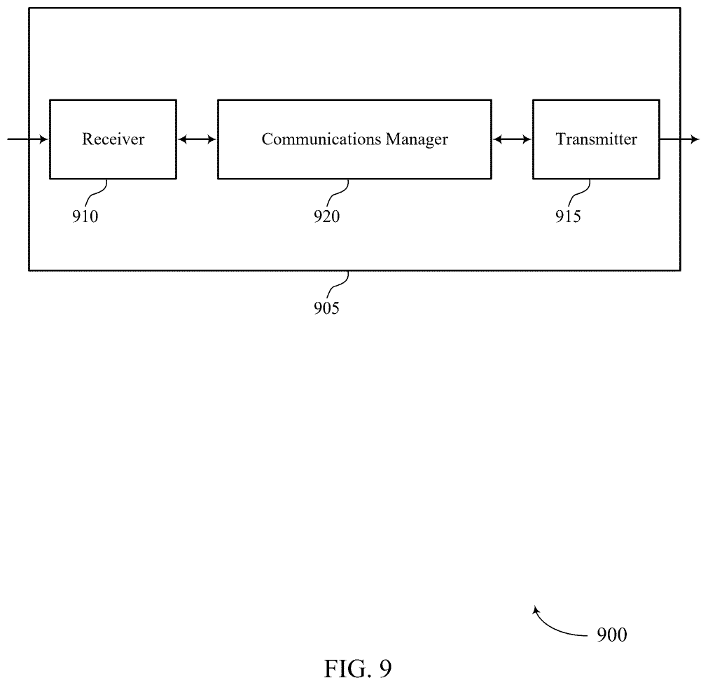

FIG. 9 shows a block diagram 900 of a device 905 that supports techniques for cell group-specific uplink WUS configuration for on-demand SIBs in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for cell group-specific uplink WUS configuration for on-demand SIBs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for establishing a connection with a UE. The communications manager 920 is capable of, configured to, or operable to support a means for outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for NES cell group-specific uplink WUS configurations, which may result in reduced power consumption and more efficient utilization of communication resources.

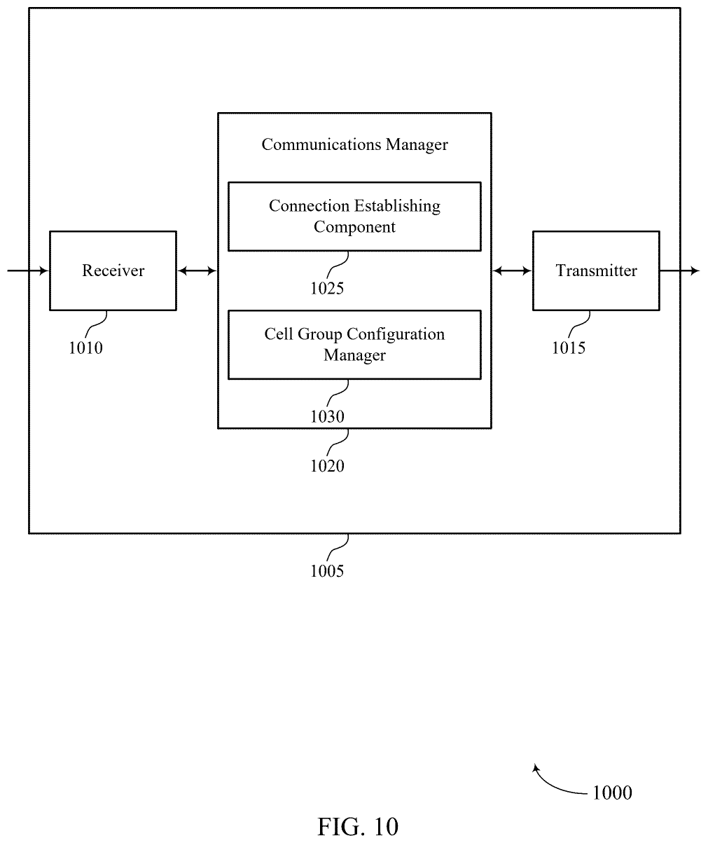

FIG. 10 shows a block diagram 1000 of a device 1005 that supports techniques for cell group-specific uplink WUS configuration for on-demand SIBs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for cell group-specific uplink WUS configuration for on-demand SIBs as described herein. For example, the communications manager 1020 may include a connection establishing component 1025 a cell group configuration manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The connection establishing component 1025 is capable of, configured to, or operable to support a means for establishing a connection with a UE. The cell group configuration manager 1030 is capable of, configured to, or operable to support a means for outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

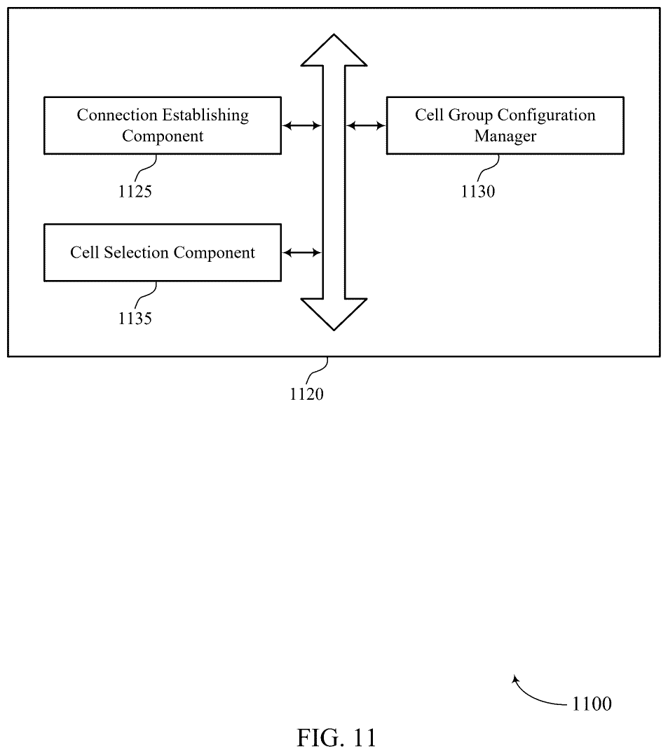

FIG. 11 shows a block diagram 1100 of a communications manager 1120 that supports techniques for cell group-specific uplink WUS configuration for on-demand SIBs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for cell group-specific uplink WUS configuration for on-demand SIBs as described herein. For example, the communications manager 1120 may include a connection establishing component 1125, a cell group configuration manager 1130, a cell selection component 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The connection establishing component 1125 is capable of, configured to, or operable to support a means for establishing a connection with a UE. The cell group configuration manager 1130 is capable of, configured to, or operable to support a means for outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

In some examples, the first set of parameters, the one or more second sets of parameters, or both include one or more parameters related to a waveform generation for an uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more SSBs, or any combination thereof.

In some examples, the cell selection component 1135 is capable of, configured to, or operable to support a means for obtaining a message indicating a first NES cell, a cell group of the one or more cell groups that includes the first NES cell, or both.

In some examples, the cell group configuration manager 1130 is capable of, configured to, or operable to support a means for outputting second signaling indicating an update to a first sub-configuration of the one or more sub-configurations.

In some examples, the signaling includes an indication of one or more NES cells included in a cell group of the one or more cell groups, PCIs of one or more NES cells included in a cell group of the one or more cell groups, a quantity of cell groups of the one or more cell groups, a quantity of NES cells in a cell group of the one or more cell groups, or any combination thereof.

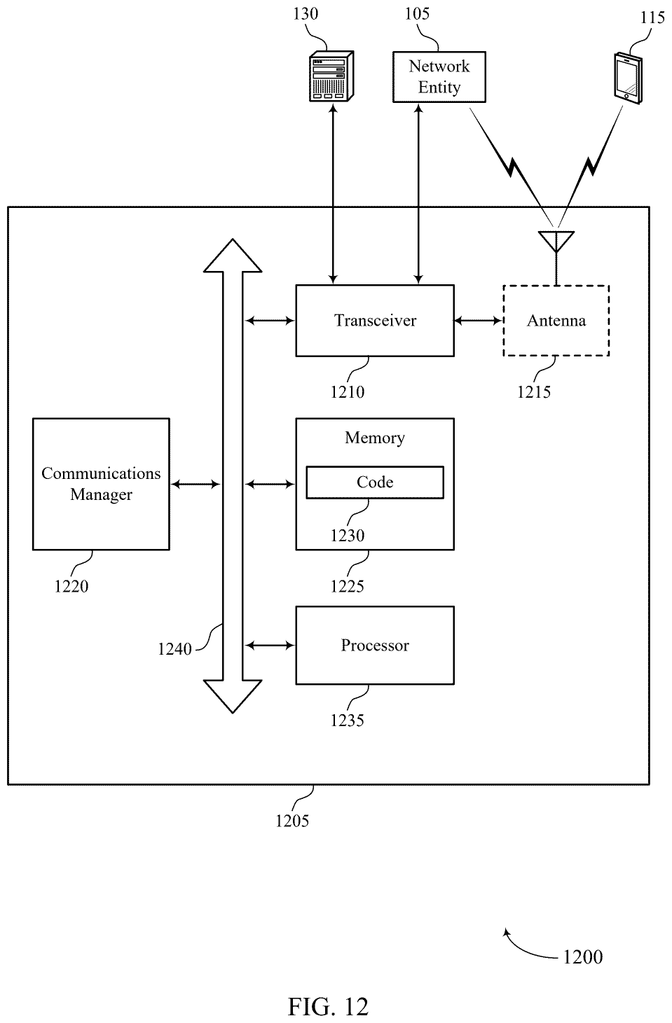

FIG. 12 shows a diagram of a system 1200 including a device 1205 that supports techniques for cell group-specific uplink WUS configuration for on-demand SIBs in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for cell group-specific uplink WUS configuration for on-demand SIBs). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for establishing a connection with a UE. The communications manager 1220 is capable of, configured to, or operable to support a means for outputting, to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups.

By including or configuring the communications manager 1220 in accordance with examples as described herein, the device 1205 may support techniques for NES cell group-specific uplink WUS configurations, which may result in reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for cell group-specific uplink WUS configuration for on-demand SIBs as described herein, or the at least one processor 1235 and the at least one memory 1225 may be otherwise configured to, individually or collectively, perform or support such operations.

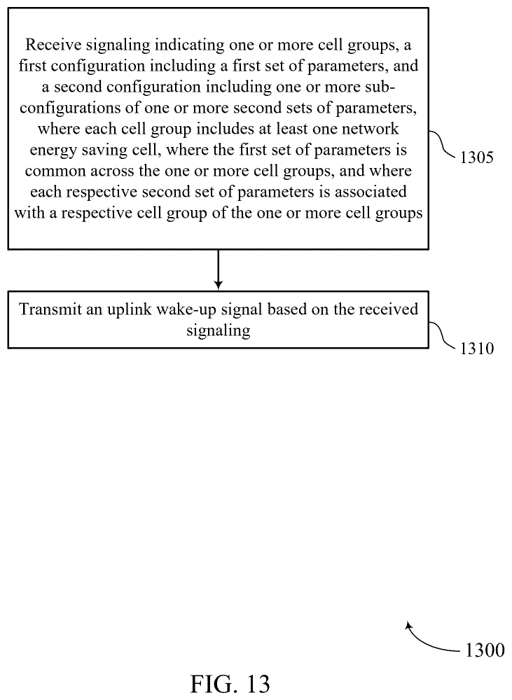

FIG. 13 shows a flowchart illustrating a method 1300 that supports techniques for cell group-specific uplink WUS configuration for on-demand SIBs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The operations of 1305 may be performed in accordance with examples as disclosed herein. In some examples, aspects of the operations of 1305 may be performed by a cell group configuration manager 725 as described with reference to FIG. 7.

At 1310, the method may include transmitting an uplink WUS based on the received signaling. The operations of 1310 may be performed in accordance with examples as disclosed herein. In some examples, aspects of the operations of 1310 may be performed by an uplink WUS transmission manager 730 as described with reference to FIG. 7.

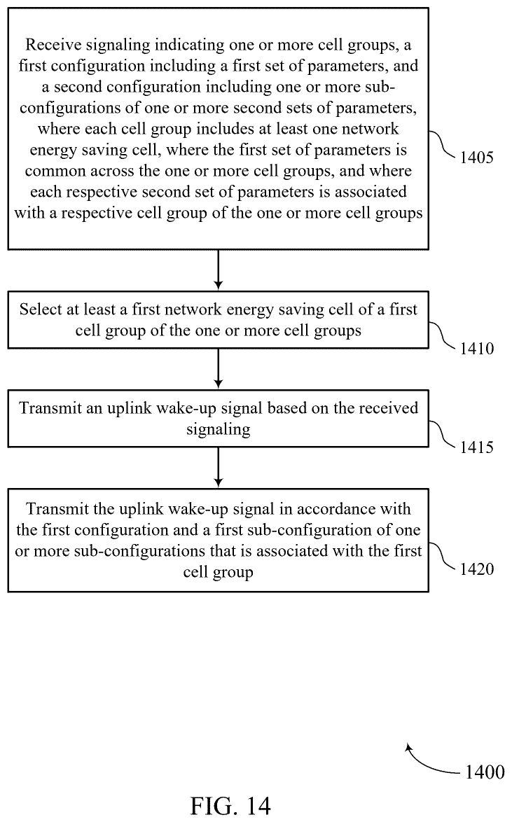

FIG. 14 shows a flowchart illustrating a method 1400 that supports techniques for cell group-specific uplink WUS configuration for on-demand SIBs in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The operations of 1405 may be performed in accordance with examples as disclosed herein. In some examples, aspects of the operations of 1405 may be performed by a cell group configuration manager 725 as described with reference to FIG. 7.

At 1410, the method may include selecting at least a first NES cell of a first cell group of the one or more cell groups. The operations of 1410 may be performed in accordance with examples as disclosed herein. In some examples, aspects of the operations of 1410 may be performed by a cell selection manager 735 as described with reference to FIG. 7.

At 1415, the method may include transmitting an uplink WUS based on the received signaling. The operations of 1415 may be performed in accordance with examples as disclosed herein. In some examples, aspects of the operations of 1415 may be performed by an uplink WUS transmission manager 730 as described with reference to FIG. 7.

At 1420, to transmit the uplink WUS, the method may include transmitting the uplink WUS in accordance with the first configuration and a first sub-configuration of one or more sub-configurations that is associated with the first cell group. The operations of 1420 may be performed in accordance with examples as disclosed herein. In some examples, aspects of the operations of 1420 may be performed by an uplink WUS transmission manager 730 as described with reference to FIG. 7.

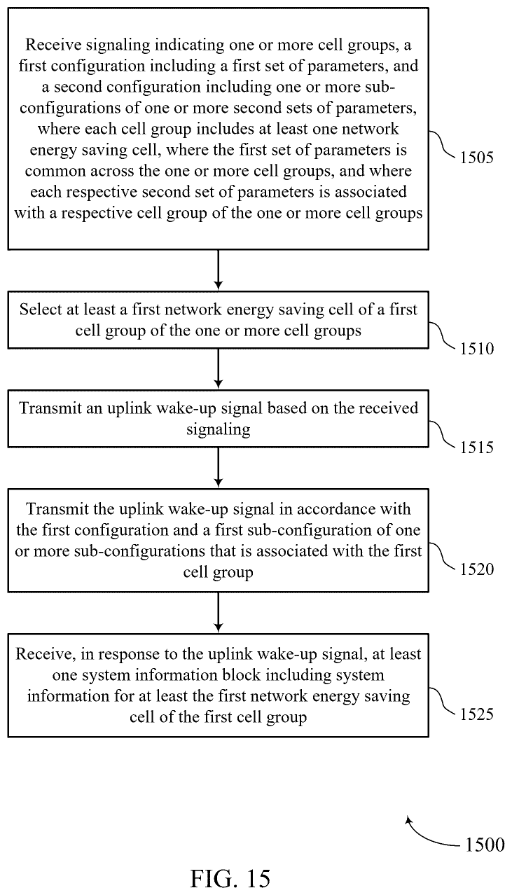

FIG. 15 shows a flowchart illustrating a method 1500 that supports techniques for cell group-specific uplink WUS configuration for on-demand SIBs in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. The operations of 1505 may be performed in accordance with examples as disclosed herein. In some examples, aspects of the operations of 1505 may be performed by a cell group configuration manager 725 as described with reference to FIG. 7.

At 1510, the method may include selecting at least a first NES cell of a first cell group of the one or more cell groups. The operations of 1510 may be performed in accordance with examples as disclosed herein. In some examples, aspects of the operations of 1510 may be performed by a cell selection manager 735 as described with reference to FIG. 7.

At 1515, the method may include transmitting an uplink WUS based on the received signaling. The operations of 1515 may be performed in accordance with examples as disclosed herein. In some examples, aspects of the operations of 1515 may be performed by an uplink WUS transmission manager 730 as described with reference to FIG. 7.

At 1520, to transmit the uplink WUS, the method may include transmitting the uplink WUS in accordance with the first configuration and a first sub-configuration of one or more sub-configurations that is associated with the first cell group. The operations of 1520 may be performed in accordance with examples as disclosed herein. In some examples, aspects of the operations of 1520 may be performed by an uplink WUS transmission manager 730 as described with reference to FIG. 7.

At 1525, the method may include receiving, in response to the uplink WUS, at least one SIB including system information for at least the first NES cell of the first cell group. The operations of 1525 may be performed in accordance with examples as disclosed herein. In some examples, aspects of the operations of 1525 may be performed by an SIB manager 740 as described with reference to FIG. 7.

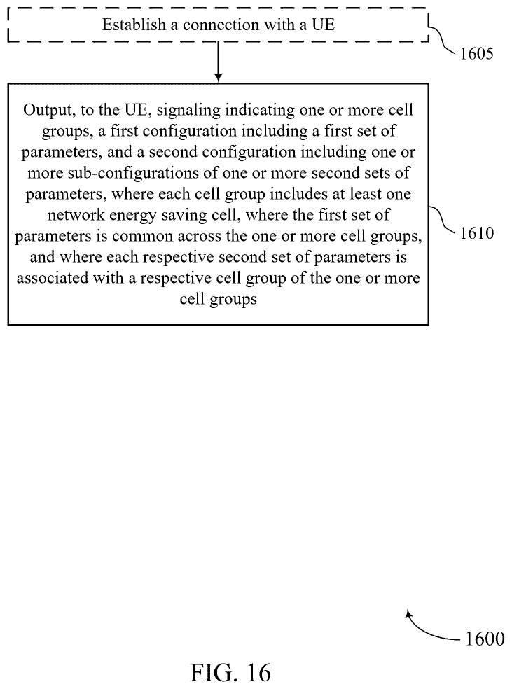

FIG. 16 shows a flowchart illustrating a method 1600 that supports techniques for cell group-specific uplink WUS configuration for on-demand SIBs in accordance with one or more aspects of the present disclosure. The operations of the method 1600 may be implemented by a network entity (e.g., a NES cell, a non-NES cell) or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

In some examples, at 1605, the method may include establishing a connection with a UE. In some examples, the method may not include establishing the connection with the UE. The operations of 1605 may be performed in accordance with examples as disclosed herein. In some examples, aspects of the operations of 1605 may be performed by a connection establishing component 1125 as described with reference to FIG. 11.

At 1610, the method may include transmitting (e.g., outputting), to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. In some examples, if the method includes establishing the connection with the UE, the signaling may be unicast signaling. If the method does not include establishing the connection with the UE, the signaling may be broadcast signaling. The operations of 1610 may be performed in accordance with examples as disclosed herein. In some examples, aspects of the operations of 1610 may be performed by a cell group configuration manager 1130 as described with reference to FIG. 11.

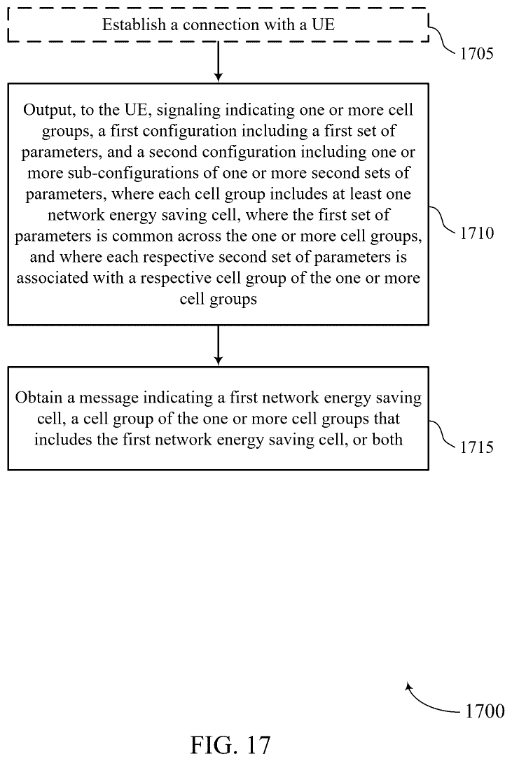

FIG. 17 shows a flowchart illustrating a method 1700 that supports techniques for cell group-specific uplink WUS configuration for on-demand SIBs in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

In some examples, at 1705, the method may include establishing a connection with a UE. In some examples, the method may not include establishing the connection with the UE. The operations of 1705 may be performed in accordance with examples as disclosed herein. In some examples, aspects of the operations of 1705 may be performed by a connection establishing component 1125 as described with reference to FIG. 11.

At 1710, the method may include transmitting (e.g., outputting), to the UE, signaling indicating one or more cell groups, a first configuration including a first set of parameters, and a second configuration including one or more sub-configurations of one or more second sets of parameters, where each cell group includes at least one NES cell, where the first set of parameters is common across the one or more cell groups, and where each respective second set of parameters is associated with a respective cell group of the one or more cell groups. In some examples, if the method includes establishing the connection with the UE, the signaling may be unicast signaling. If the method does not include establishing the connection with the UE, the signaling may be broadcast signaling. The operations of 1710 may be performed in accordance with examples as disclosed herein. In some examples, aspects of the operations of 1710 may be performed by a cell group configuration manager 1130 as described with reference to FIG. 11.

At 1715, the method may include obtaining a message indicating a first NES cell, a cell group of the one or more cell groups that includes the first NES cell, or both. The operations of 1715 may be performed in accordance with examples as disclosed herein. In some examples, aspects of the operations of 1715 may be performed by a cell selection component 1135 as described with reference to FIG. 11.

The following provides an overview of aspects of the present disclosure:

Aspect 1: A method for wireless communications at a UE, comprising: receiving signaling indicating one or more cell groups, a first configuration including a first set of parameters, and a second configuration including one or more sub-configurations of one or more second sets of parameters, wherein each cell group includes at least one NES cell, wherein the first set of parameters is common across the one or more cell groups, and wherein each respective second set of parameters is associated with a respective cell group of the one or more cell groups; and transmitting an uplink WUS based at least in part on the received signaling.

Aspect 2: The method of aspect 1, wherein transmitting the uplink WUS comprises: selecting at least a first NES cell of a first cell group of the one or more cell groups; and transmitting the uplink WUS in accordance with the first configuration and a first sub-configuration of one or more sub-configurations that is associated with the first cell group.

Aspect 3: The method of aspect 2, further comprising: receiving, in response to the uplink WUS, at least one SIB including system information for at least the first NES cell of the first cell group.

Aspect 4: The method of aspect 3, further comprising: transmitting a capability message indicating a quantity of SIBs, wherein the receiving the at least one SIB is in accordance with the capability message.

Aspect 5: The method of any of aspects 1 through 4, wherein the first set of parameters, the one or more second sets of parameters, or both include one or more parameters related to a waveform generation for the uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more SSBs, or any combination thereof.

Aspect 6: The method of any of aspects 1 through 5, wherein transmitting the uplink WUS in accordance with a first uplink WUS configuration comprises: transmitting the uplink WUS in accordance with a RACH procedure.

Aspect 7: The method of any of aspects 1 through 6, further comprising: transmitting a message indicating a first NES cell, a cell group of the one or more cell groups that includes the first NES cell, or both.

Aspect 8: The method of any of aspects 1 through 7, wherein receiving the signaling indicating the one or more cell groups comprises: receiving the signaling via a broadcast message or a unicast message.

Aspect 9: The method of any of aspects 1 through 8, further comprising: receiving second signaling indicating an update to a first sub-configuration of the one or more sub-configurations; and transmitting a retransmission of the uplink WUS in accordance with the updated first sub-configuration.

Aspect 10: The method of any of aspects 1 through 9, wherein the received signaling includes an indication of one or more NES cells included in a cell group of the one or more cell groups, physical layer cell identities of one or more NES cells included in a cell group of the one or more cell groups, a quantity of cell groups of the one or more cell groups, a quantity of NES cells in a cell group of the one or more cell groups, or any combination thereof.

Aspect 11: A method for wireless communications at a network entity, comprising: establishing a connection with a UE; and outputting, to the UE, signaling indicating one or more cell groups, a first configuration including a first set of parameters, and a second configuration including one or more sub-configurations of one or more second sets of parameters, wherein each cell group includes at least one NES cell, wherein the first set of parameters is common across the one or more cell groups, and wherein each respective second set of parameters is associated with a respective cell group of the one or more cell groups.

Aspect 12: The method of aspect 11, wherein the first set of parameters, the one or more second sets of parameters, or both include one or more parameters related to a waveform generation for an uplink WUS, time resources for the uplink WUS, frequency resources for the uplink WUS, a cyclic shift for the uplink WUS, a transmission power of the uplink WUS, configuration information for an acknowledgement to the uplink WUS, configuration information for retransmission of the uplink WUS, configuration information for one or more SSBs, or any combination thereof.

Aspect 13: The method of any of aspects 11 through 12, further comprising: obtaining a message indicating a first NES cell, a cell group of the one or more cell groups that includes the first NES cell, or both.

Aspect 14: The method of any of aspects 11 through 13, further comprising: outputting second signaling indicating an update to a first sub-configuration of the one or more sub-configurations.

Aspect 15: The method of any of aspects 11 through 14, wherein the signaling includes an indication of one or more NES cells included in a cell group of the one or more cell groups, physical layer cell identities of one or more NES cells included in a cell group of the one or more cell groups, a quantity of cell groups of the one or more cell groups, a quantity of NES cells in a cell group of the one or more cell groups, or any combination thereof.

Aspect 16: A UE for wireless communications, comprising one or more memories storing processor-executable code, and one or more processors coupled with the one or more memories and individually or collectively operable to execute the code to cause the UE to perform a method of any of aspects 1 through 10.

Aspect 17: A UE for wireless communications, comprising at least one means for performing a method of any of aspects 1 through 10.

Aspect 18: A non-transitory computer-readable medium storing code for wireless communications, the code comprising instructions executable by one or more processors to perform a method of any of aspects 1 through 10.

Aspect 19: A network entity for wireless communications, comprising one or more memories storing processor-executable code, and one or more processors coupled with the one or more memories and individually or collectively operable to execute the code to cause the network entity to perform a method of any of aspects 11 through 15.

Aspect 20: A network entity for wireless communications, comprising at least one means for performing a method of any of aspects 11 through 15.

Aspect 21: A non-transitory computer-readable medium storing code for wireless communications, the code comprising instructions executable by one or more processors to perform a method of any of aspects 11 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive signaling indicating one or more cell groups, a first configuration including a first set of parameters, and a second configuration including one or more sub-configurations of one or more second sets of parameters, wherein each cell group includes at least one network energy saving cell, wherein the first set of parameters is common across the one or more cell groups, and wherein each respective second set of parameters is associated with a respective cell group of the one or more cell groups; and
transmit an uplink wake-up signal based at least in part on the received signaling.

2. The UE of claim 1, wherein, to transmit the uplink wake-up signal, the one or more processors are individually or collectively operable to execute the code to cause the UE to:
select at least a first network energy saving cell of a first cell group of the one or more cell groups; and
transmit the uplink wake-up signal in accordance with the first configuration and a first sub-configuration of one or more sub-configurations that is associated with the first cell group.

3. The UE of claim 2, wherein the one or more processors are individually or collectively further operable to execute the code to cause the UE to:
receive, in response to the uplink wake-up signal, at least one system information block including system information for at least the first network energy saving cell of the first cell group.

4. The UE of claim 3, wherein the one or more processors are individually or collectively further operable to execute the code to cause the UE to:
transmit a capability message indicating a quantity of system information blocks, wherein the receiving the at least one system information block is in accordance with the capability message.

5. The UE of claim 1, wherein the first set of parameters, the one or more second sets of parameters, or both include one or more parameters related to a waveform generation for the uplink wake-up signal, time resources for the uplink wake-up signal, frequency resources for the uplink wake-up signal, a cyclic shift for the uplink wake-up signal, a transmission power of the uplink wake-up signal, configuration information for an acknowledgement to the uplink wake-up signal, configuration information for retransmission of the uplink wake-up signal, configuration information for one or more synchronization signal blocks, or any combination thereof.

6. The UE of claim 1, wherein, to transmit the uplink wake-up signal in accordance with a first uplink wake-up signal configuration, the one or more processors are individually or collectively operable to execute the code to cause the UE to:
transmit the uplink wake-up signal in accordance with a random access channel procedure.

7. The UE of claim 1, wherein the one or more processors are individually or collectively further operable to execute the code to cause the UE to:
transmit a message indicating a first network energy saving cell, a cell group of the one or more cell groups that includes the first network energy saving cell, or both.

8. The UE of claim 1, wherein, to receive the signaling indicating the one or more cell groups, the one or more processors are individually or collectively operable to execute the code to cause the UE to:
receive the signaling via a broadcast message or a unicast message.

9. The UE of claim 1, wherein the one or more processors are individually or collectively further operable to execute the code to cause the UE to:
receive second signaling indicating an update to a first sub-configuration of the one or more sub-configurations; and
transmit a retransmission of the uplink wake-up signal in accordance with the updated first sub-configuration.

10. The UE of claim 1, wherein the received signaling includes an indication of one or more network energy saving cells included in a cell group of the one or more cell groups, physical layer cell identities of one or more network energy saving cells included in a cell group of the one or more cell groups, a quantity of cell groups of the one or more cell groups, a quantity of network energy saving cells in a cell group of the one or more cell groups, or any combination thereof.

11. A method for wireless communications at a user equipment (UE), comprising:
receiving signaling indicating one or more cell groups, a first configuration including a first set of parameters, and a second configuration including one or more sub-configurations of one or more second sets of parameters, wherein each cell group includes at least one network energy saving cell, wherein the first set of parameters is common across the one or more cell groups, and wherein each respective second set of parameters is associated with a respective cell group of the one or more cell groups; and
transmitting an uplink wake-up signal based at least in part on the received signaling.

12. The method of claim 11, wherein transmitting the uplink wake-up signal comprises:
selecting at least a first network energy saving cell of a first cell group of the one or more cell groups; and
transmitting the uplink wake-up signal in accordance with the first configuration and a first sub-configuration of one or more sub-configurations that is associated with the first cell group.

13. The method of claim 12, further comprising:
receiving, in response to the uplink wake-up signal, at least one system information block including system information for at least the first network energy saving cell of the first cell group.

14. The method of claim 13, further comprising:
transmitting a capability message indicating a quantity of system information blocks, wherein the receiving the at least one system information block is in accordance with the capability message.

15. The method of claim 11, wherein the first set of parameters, the one or more second sets of parameters, or both include one or more parameters related to a waveform generation for the uplink wake-up signal, time resources for the uplink wake-up signal, frequency resources for the uplink wake-up signal, a cyclic shift for the uplink wake-up signal, a transmission power of the uplink wake-up signal, configuration information for an acknowledgement to the uplink wake-up signal, configuration information for retransmission of the uplink wake-up signal, configuration information for one or more synchronization signal blocks, or any combination thereof.

16. The method of claim 11, wherein transmitting the uplink wake-up signal in accordance with a first uplink wake-up signal configuration comprises:
transmitting the uplink wake-up signal in accordance with a random access channel procedure.

17. The method of claim 11, further comprising:
transmitting a message indicating a first network energy saving cell, a cell group of the one or more cell groups that includes the first network energy saving cell, or both.

18. The method of claim 11, further comprising:
receiving second signaling indicating an update to a first sub-configuration of the one or more sub-configurations; and
transmitting a retransmission of the uplink wake-up signal in accordance with the updated first sub-configuration.

19. The method of claim 11, wherein the received signaling includes an indication of one or more network energy saving cells included in a cell group of the one or more cell groups, physical layer cell identities of one or more network energy saving cells included in a cell group of the one or more cell groups, a quantity of cell groups of the one or more cell groups, a quantity of network energy saving cells in a cell group of the one or more cell groups, or any combination thereof.

20. A non-transitory computer-readable medium storing code for wireless communications, the code comprising instructions executable by one or more processors to:
receive signaling indicating one or more cell groups, a first configuration including a first set of parameters, and a second configuration including one or more sub-configurations of one or more second sets of parameters, wherein each cell group includes at least one network energy saving cell, wherein the first set of parameters is common across the one or more cell groups, and wherein each respective second set of parameters is associated with a respective cell group of the one or more cell groups; and
transmit an uplink wake-up signal based at least in part on the received signaling.
